(19) United States
(12) Patent Application Publication
(10) Pub. No.: US 2026/0327000 A1
(43) Pub. Date: Oct. 22, 2026

(54) SINGLE-USE BEVERAGE CARTRIDGE WITH COFFEE AND FLAVORING MATERIAL

(71) Applicant: Lee Redden, Palo Alto, CA (US)

(72) Inventors: Lee Redden, Palo Alto, CA (US); Adam Teddy Eller, Santa Clara, CA (US)

(21) Appl. No.: 19/722,625

(22) Filed: Jun. 26, 2026

Related U.S. Application Data
(63) Continuation of application No. PCT/US2026/010984, filed on Jan. 12, 2026.
Application No. PCT/US2026/010984 is a continuation of application No. 19/016,920, filed on Jan. 10, 2025, now abandoned.

(51) Int. Cl. B65D 85/804

(52) U.S. Cl. CPC B65D 85/8067; B65D 85/8052; B65D 85/8061

(57) ABSTRACT

One variation of a beverage cartridge includes: a cup; a filter; an upper lid; and a lower lid. The cup includes: an upper rim defining upper orifice; and a lower rim defining lower orifice. The filter is arranged within the cup. The upper lid: is arranged across the upper rim; encloses the upper orifice of the cup; cooperates with the filter to define an upper internal cup volume occupied by a first portion of coffee material; and is puncturable by an inlet needle of a brewing machine. The lower lid: is arranged across the lower rim of the cup; encloses the lower orifice; cooperating with the cup to define a lower internal cup volume below the filter and occupied by a second portion of flavoring material; and is puncturable by an outlet needle of the brewing machine.

### CROSS-REFERENCE TO RELATED APPLICATIONS

This Application is a continuation of PCT Application No. PCT/US2026/010984, filed on 12 Jan. 2026, which claims priority to U.S. patent application Ser. No. 19/016,920, filed on 10 Jan. 2025, each of which is incorporated herein by reference in its entirety.

This Application claims the benefit of PCT/US2026/010984 pursuant to 35 U.S.C. § § 120 and 365(c).

### TECHNICAL FIELD

This invention relates generally to the field of brewed beverages and, more specifically, to a new and useful single-use beverage cartridge with coffee and flavoring material in the field of brewed beverages.

### BRIEF DESCRIPTION OF THE FIGURES

FIG. 1 is a flowchart representation of a beverage cartridge;

FIG. 2 is a flowchart representation of one variation of the beverage cartridge;

FIG. 3 is a flowchart representation of one variation of the beverage cartridge;

FIG. 4 is a flowchart representation of one variation of the beverage cartridge;

FIG. 5 is a flowchart representation of one variation of the beverage cartridge;

FIG. 6 is a flowchart representation of one variation of the beverage cartridge;

FIG. 7 is a flowchart representation of one variation of the beverage cartridge;

FIG. 8 is a flowchart representation of one variation of the beverage cartridge;

FIG. 9 is a graphical representation of a powdered flavoring of one variation of the beverage cartridge;

FIG. 10 is a graphical representation of a liquid flavoring of one variation of the beverage cartridge;

FIG. 11 is a flowchart representation of one variation of the beverage cartridge;

FIG. 12 is a flowchart representation of one variation of the beverage cartridge; and

FIG. 13 is a flowchart representation of one variation of the beverage cartridge.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Beverage Cartridge With Double Lid

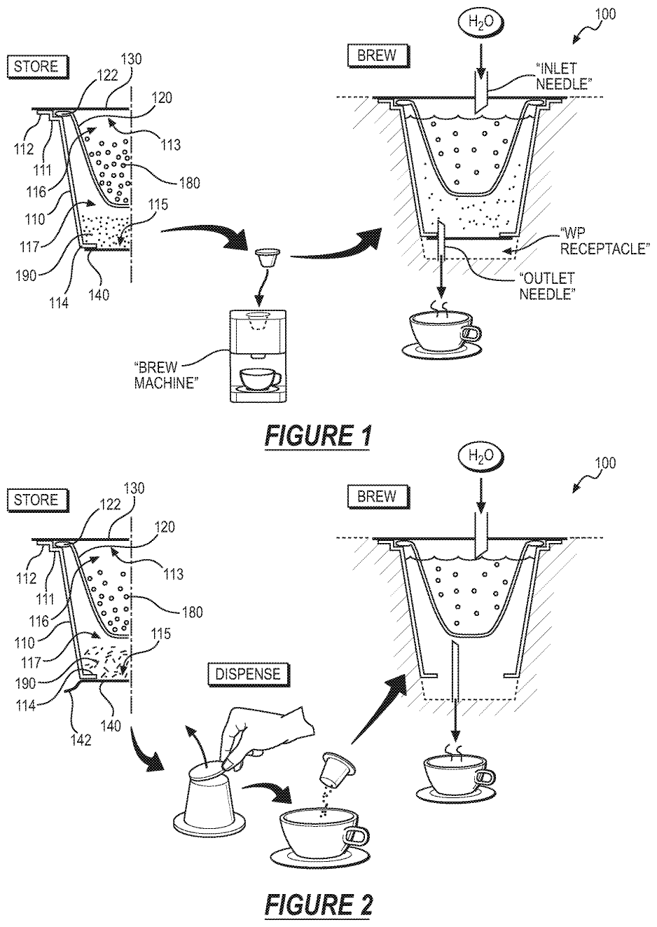

As shown in FIG. 1, a beverage cartridge 100 includes: a cup 110; a filter 120; an upper lid 130; and a lower lid 140.

The cup 110 includes: an upper rim 112 defining an upper orifice 113; and a lower rim 114 defining a lower orifice 115.

The filter 120 is arranged within the cup 110.

The upper lid 130: is arranged across the upper rim 112; encloses the upper orifice 113 of the cup 110; cooperates with the filter 120 to define an upper internal cup volume 116 occupied by a first portion of coffee material 180 (or “beverage medium”); and is puncturable by an inlet needle of a brewing machine.

The lower lid 140: is arranged across the lower rim 114 of the cup 110; encloses the lower orifice 115; cooperates with the cup 110 to define a lower internal cup volume 117 below the filter 120 and occupied by a second portion of flavoring material 190; and is puncturable by an outlet needle of the brewing machine.

### 1.1 Variation: Double Lid With Coffee Grounds and Flavoring

As shown in FIGS. 1 and 8, one variation of the beverage cartridge 100 includes: a first portion of coffee grounds; and a second portion of flavoring.

In this variation, the cup 110 includes: an upper rim 112; and a lower rim 114.

In this variation, the filter 120 is arranged within the cup 110.

In this variation, the upper lid 130: is arranged across the upper rim 112; cooperates with the filter 120 to define an upper internal cup volume 116 occupied by the first portion of coffee grounds; and is puncturable by an inlet needle of a brewing machine.

In this variation, the lower lid 140: is arranged across the lower rim 114 of the cup 110; cooperates with the cup 110 to define a lower internal cup volume 117 below the filter 120 and occupied by the second portion of flavoring; and is puncturable by an outlet needle of the brewing machine.

### 1.2 Variation: Single Lid With Coffee Grounds and Flavoring

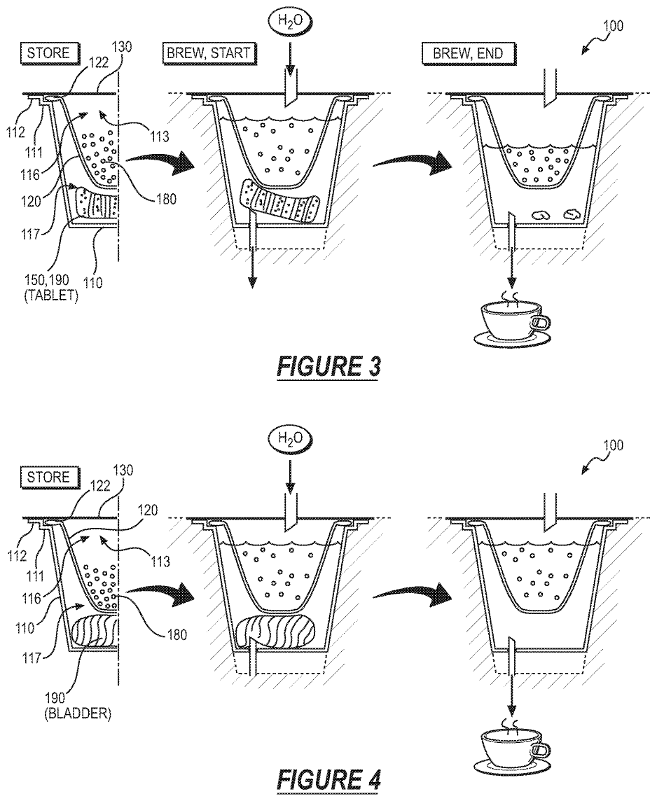

As shown in FIGS. 3-7, another variation of the beverage cartridge 100 includes a first portion of coffee material 180.

In this variation, the cup 110 includes: an upper rim 112; and a base.

In this variation, the filter 120 is arranged within the cup 110.

In this variation, the upper lid 130: is arranged across the upper rim 112; cooperates with the filter 120 to define an upper internal cup volume 116 occupied by the first portion of coffee material 180; and is puncturable by an inlet needle of a brewing machine.

In this variation, the beverage cartridge 100 also includes a second portion of flavoring material 190: arranged between the filter 120 and the base of the cup 110; and isolated from the first portion of coffee material 180.

### 1.3 Variation: Single Lid With Coffee Grounds and Flavoring

As shown in FIGS. 3-7, another variation of the beverage cartridge 100 includes a first portion of coffee material 180.

In this variation, the cup 110 includes an upper rim 112.

In this variation, the filter 120 is arranged within the cup 110.

In this variation, the upper lid 130: is arranged across the upper rim 112; cooperates with the filter 120 to define an upper internal cup volume 116 occupied by the first portion of coffee material 180; and is puncturable by an inlet needle of a brewing machine.

In this variation, the beverage cartridge 100 also includes a second portion of flavoring material 190: arranged between the filter 120 and the base of the cup 110; and isolated from the first portion of coffee material 180.

### 2. Applications

Generally, the beverage cartridge 100 defines a single-serving “pod” configured to load into an automatic pod-based brewing machine. In particular, the beverage cartridge 100 defines two internal volumes including: an upper internal cup volume 116 defined between an upper lid 130 (e.g., an aluminum foil lid) and a filter 120 and containing coffee grounds; and a lower internal cup volume 117 defined below the filter 120 (e.g., between the filter 120 and a base of the cup 110, between the filter 120 and a lower lid 140) and containing flavoring, such as a liquid or powdered dairy or non-dairy milk product and sugar.

More specifically, the beverage cartridge 100 can include: a frustoconical cup formed of a food-grade plastic (e.g., polypropylene, polyethylene terephthalate); an upper lid 130 formed of aluminum foil and/or a polyethylene film and laminated across an upper rim 112 of the cup 110; and a filter 120 formed of a food-grade paper or non-woven synthetic fiber (e.g., polypropylene) and configured to pass water and coffee ground particulate while retaining larger coffee particles.

The beverage cartridge 100 also contains both: coffee grounds above the filter 120; and flavoring below the filter 120 and isolated from the coffee ground—such as by the filter 120, a separate internal seal below the filter 120, or a separate internal vessel—while the beverage cartridge 100 is stored. When the beverage cartridge 100 is loaded into a cup receptacle within the brewing machine, an inlet needle (or a cluster of inlet needles) of the brewing machine pierces the upper lid 130 of the beverage cartridge 100. Concurrently, an outlet needle of the brewing machine pierces the base or a lower lid 140 of the beverage cartridge 100. The inlet needle then feeds heated water under pressure into the upper internal cup volume 116. This heated water: wets the coffee grounds in the upper internal cup volume 116; extracts flavors (e.g., oils, acids, sugars, volatile aromatic compounds) from the coffee grounds; passes through the filter 120 into the lower internal cup volume 117; mixes with the flavoring material 190 in the lower internal cup volume 117; and then exits the beverage cartridge 100 via the outlet needle. The brewing machine then dispenses this coffee extraction and flavoring mixture, such as into a coffee mug.

Therefore, the beverage cartridge 100 can define two separate internal volumes that separately store coffee grounds and flavoring that are only combined in the presence of heated water pumped through the beverage cartridge 100 by a brewing machine.

### 2.1 Powdered Flavoring in Lower Internal Cup Volume

In one implementation shown in FIG. 1, the beverage cartridge 100 stores dry, loose powdered flavoring in the lower internal cup volume 117.

In this implementation, when the inlet needle injects heated water into the upper internal cup volume 116, this heated water: wets the coffee grounds in the upper internal cup volume 116; extracts flavors from the coffee grounds; passes through the filter 120 into the lower internal cup volume 117; wets and mixes with the dry, loose powdered flavoring in the lower internal cup volume 117; and then exits the beverage cartridge 100 via the outlet needle.

In this implementation, the beverage cartridge 100 can also include an anti-caking agent (e.g., silicon dioxide, tricalcium phosphate) to reduce clumping and improve mixing of the powdered flavoring with water flowing into the lower internal cup volume 117.

### 2.2 Powdered Flavoring Tablet in Lower Internal Cup Volume

In another implementation shown in FIG. 3, the flavoring material 190 includes a powder, compressed into a rigid flavoring tablet such as a circular disc and including an array of perforations smaller than the outlet needle, the perforations increasing a surface area of the tablet.

In this implementation, when the outlet needle pierces the base of the cup 110 or the lower lid 140 during a brew cycle, the flavoring material 190 tablet can: shield the filter 120 from puncture by the outlet needle; and (initially) form a rigid framework around the filter 120 to maintain a shape of the filter 120 and to prevent collapse of the filter 120 during injection of heated water under pressure into the upper internal cup volume 116.

When the inlet needle injects heated water into the upper internal cup volume 116, this heated water: wets the coffee grounds in the upper internal cup volume 116; extracts flavors from the coffee grounds; passes through the filter 120 into the lower internal cup volume 117; flows around and through the flavoring material 190 tablet; dissolves flavoring from the surface of the flavoring material 190 tablet; and then exits the beverage cartridge 100 via the outlet needle.

### 2.3 Liquid Flavoring in Bladder

In another implementation shown in FIG. 4, the flavoring material 190 includes a liquid, such as: dairy cream and sugar; or a slurry of water, milk, or cream mixed with milk powder, sugar, corn syrup, dextrose, emulsifier, stabilizer or thickener, natural or artificial flavor, and/or preservative.

In this implementation, the flavoring material 190 is contained in a water-soluble bladder, such as a thin-film polyvinyl alcohol pouch; and this water-soluble bladder is stored in the beverage cartridge 100 below the filter 120.

When the outlet needle pierces the base of the cup 110 or the lower lid 140 during a brew cycle, the outlet needle can also pierce the water-soluble bladder such that the liquid flavoring flows out of the lower internal cup volume 117 via the outlet needle and/or flows across the lower internal cup volume 117. Furthermore, when the inlet needle (concurrently) pierces the upper lid 130 and injects heated water into the upper internal cup volume 116, this heated water: wets the coffee grounds in the upper internal cup volume 116; extracts flavors from the coffee grounds; passes through the filter 120 into the lower internal cup volume 117; flows around and dissolves the water-soluble bladder; mixes with the liquid flavoring; and then exits the beverage cartridge 100 via the outlet needle.

### 2.4 Liquid Flavoring in Blister

In another implementation shown in FIG. 6, the base of the cup 110 defines a blister 119 (or semi-spherical dome) extending opposite the filter 120. In this implementation: the flavoring material 190 includes a liquid, as described above; and the beverage cartridge 100 further includes an internal seal bonded to the interior face of the base and sealing the liquid flavoring within the blister 119.

In this implementation, if a user desires a cup 110 of coffee with flavoring (e.g., milk and sugar), the user may depress the blister 119 inwardly toward the interior of the cup 110 prior to loading the beverage cartridge 100 into the brewing machine. Resulting increased fluid pressure within the blister 119 may tear the internal seal or delaminate the internal seal from the base of the cup 110, thereby releasing the flavoring material 190 into the lower internal cup volume 117.

Once the user loads the beverage cartridge 100 into the brewing machine, the inlet needle pierces the upper lid 130 of the beverage cartridge 100 and injects heated water into the upper internal cup volume 116. This heated water: wets the coffee grounds in the upper internal cup volume 116; extracts flavors from the coffee grounds; passes through the filter 120 into the lower internal cup volume 117; mixes with the liquid flavoring in the lower internal cup volume 117; and then exits the beverage cartridge 100 via the outlet needle.

Furthermore, in this implementation, the blister 119 can be centered on the base of the cup 110 and can circumscribe a diameter that maintains the blister 119 inset from the outlet needle of the brewing machine when the beverage cartridge 100 is loaded into the cup receptacle. Accordingly, if the user does not desire a cup 110 of coffee with flavoring, the user may not depress the blister 119 before loading the beverage cartridge 100 into the cup receptacle, thereby preserving the liquid flavoring within the blister 119.

When the outlet needle pierces the base of the cup 110 or the lower lid 140 during a brew cycle, the outlet needle can also pierce the water-soluble bladder such that the liquid flavoring flows out of the lower internal cup volume 117 via the outlet needle and/or flows across the lower internal cup volume 117. Furthermore, when the inlet needle (concurrently) pierces the upper lid 130 and injects heated water into the upper internal cup volume 116, this heated water: wets the coffee grounds in the upper internal cup volume 116; extracts flavors from the coffee grounds; passes through the filter 120 into the lower internal cup volume 117; flows around and dissolves the water-soluble bladder; mixes with the liquid flavoring; and then exits the beverage cartridge 100 via the outlet needle.

### 2.5 Liquid Flavoring Behind Internal Seal

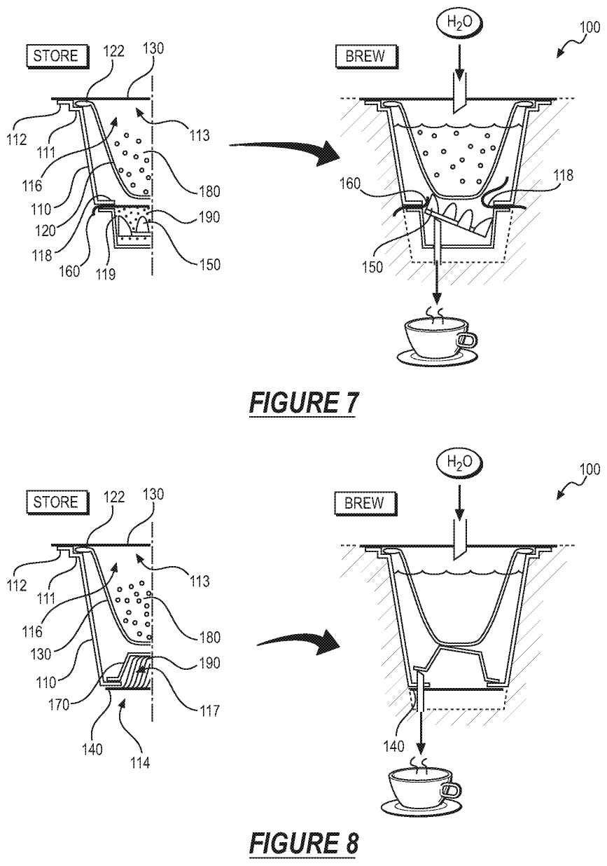

In a similar implementation shown in FIG. 7, the cup 110 includes an intermediate shoulder 118 between the upper rim 112 and the base or the lower rim 114 of the cup 110. In this implementation, an interior seal 160 (e.g., of aluminum foil) is bonded to the intermediate shoulder 118 and separates the upper internal cup volume 116 and the filter 120 from the lower internal cup volume 117. The flavoring material 190 includes a liquid, as described above, sealed within the lower internal cup volume 117 by the interior seal 160. A filter guard is also sealed within the lower internal cup volume 117 by the interior seal 160.

In this implementation, when the outlet needle pierces the base of the cup 110 or the lower lid 140 during a brew cycle, the outlet needle can also drive the filter guard upwardly against the interior seal 160, thereby: tearing the interior seal 160 and/or delaminating the interior seal 160 from the intermediate shoulder 118; and opening the lower internal cup volume 117 to the upper internal cup volume 116. When the inlet needle (concurrently) pierces the upper lid 130 and injects heated water into the upper internal cup volume 116, this heated water: wets the coffee grounds in the upper internal cup volume 116; extracts flavors from the coffee grounds; passes through the filter 120 into the lower internal cup volume 117; mixes with the liquid flavoring in the lower internal cup volume 117; and then exits the beverage cartridge 100 via the outlet needle.

### 2.6 Liquid Flavoring in Secondary Internal Vessel

In a similar implementation shown in FIG. 8, the beverage cartridge 100 includes a secondary internal vessel 170 inverted and bonded to the base of the cup 110 to enclose the lower internal cup volume 117. In this implementation, the flavoring material 190 includes a liquid, as described above, sealed within the lower internal cup volume 117 between the secondary internal vessel 170 and the base of the cup 110.

In this implementation, when the outlet needle pierces the base of the cup 110 or the lower lid 140 during a brew cycle, the outlet needle can also drive against a rim of the secondary internal vessel 170, thereby: delaminating the secondary internal vessel 170 from the base of the cup 110; and opening the lower internal cup volume 117 to the upper internal cup volume 116. When the inlet needle (concurrently) pierces the upper lid 130 and injects heated water into the upper internal cup volume 116, this heated water: wets the coffee grounds in the upper internal cup volume 116; extracts flavors from the coffee grounds; passes through the filter 120 into the lower internal cup volume 117; mixes with the liquid flavoring in the lower internal cup volume 117; and then exits the beverage cartridge 100 via the outlet needle.

### 2.7 Powdered Flavoring Behind Removable Lower Lid

In yet another implementation shown in FIG. 2, the beverage cartridge 100: stores dry, loose powdered flavoring in the lower internal cup volume 117; and includes a lower lid 140 (e.g., formed of aluminum foil) with a pull tab 142. In this implementation, prior to insertion of the beverage cartridge 100 into the cup receptacle of a brewing machine, a user may remove the lower lid 140 from the cup 110 via the pull tab 142 and dispense the powdered flavoring into a coffee mug.

In this implementation, when the inlet needle injects heated water into the upper internal cup volume 116, this heated water: wets the coffee grounds in the upper internal cup volume 116; extracts flavors from the coffee grounds; passes through the filter 120 into the cup receptacle of the brewing machine; and then flows into through the outlet needle—arranged in a base of the cup receptacle—into the coffee mug.

### 2.8 Other Beverages

The beverage cartridge 100 is described herein: as defining an upper internal cup volume 116 containing coffee grounds; as defining a lower internal cup volume 117 containing flavoring (e.g., liquid or powdered dairy or non-dairy milk); as including a filter 120 configured to pass water but retain the coffee grounds above the lower internal cup volume 117; and processable by an automatic brewing machine to brew a single serving of coffee in the upper internal cup volume 116, to mix this coffee with the flavoring material 190 in the lower internal cup volume 117, and to output a single serving of coffee and flavoring.

However, the beverage cartridge 100 can be configured to support brewing of other single-serving beverages with flavoring. For example, the beverage cartridge 100 can include: tea leaves stored in the upper internal cup volume 116; flavoring (e.g., liquid or powdered dairy or non-dairy milk) stored in the lower internal cup volume 117; a filter 120 configured to pass water by retaining tea leaves above the lower internal cup volume 117; and processable by the automatic brewing machine to brew a single serving of tea in the upper internal cup volume 116, to mix this tea with the flavoring material 190 in the lower internal cup volume 117, and to output a single serving of tea and flavoring.

### 3. Manufacturing and Materials

Generally, the cup 110 can define a unitary structure formed of a polymer (e.g., polypropylene, polyethylene terephthalate), such as via injection molding, or thermoforming. Alternatively, as described below, the cup 110 can include multiple cup sections that are formed in similar materials and via similar techniques and then assembled (e.g., by heat sealing or thermal bonding) to form the cup 110.

The filter 120 can be formed of a food-grade paper (e.g., bleached or unbleached cellulose fiber paper) or a non-woven synthetic fiber (e.g., polypropylene). The filter 120 functions to retain the coffee grounds in the upper internal cup volume 116 during storage and to pass water and coffee ground particulate while retaining larger coffee grounds in the upper internal cup volume 116 during a brew cycle. In one implementation, the filter 120 is mechanically retained within the cup 110. In this implementation, the cup 110 can: define a circular filter seat 111 (or “filter groove”) inset from the upper rim 112 and circumscribing the upper orifice 113 defined by the cup 110; and include the upper edge of the filter 120 including a rigid or reinforced filter flange 122 that seats in, mechanically locks against, and/or seals against the filter seat 111. Additionally or alternatively, the upper edge or filter flange 122 of the filter 120 can be bonded (e.g., thermally or via an adhesive) or ultrasonically welded to the cup 110 proximal the upper rim 112 of the cup 110.

The upper lid 130 can include an aluminum foil—such as with a polyethylene film coating—laminated across the upper rim 112 of the cup 110. In particular, the upper lid 130 can: function as a barrier that resists oxygen, moisture, and light ingress through the upper orifice 113 of the cup 110; and/or can mechanically retain the filter flange 122 within the filter seat 111. The upper lid 130 is also puncturable or (“pierceable”) by the inlet needle of the brewing machine. The upper rim 112 of the cup 110 can extend outwardly from the upper orifice 113, and the upper lid 130 can be bonded to and sealed against the upper rim 112 of the cup 110, such as via heat sealing (i.e., thermal bonding).

In the variation of the beverage cartridge 100 described above that includes a lower lid 140, the cup 110 can define a lower orifice 115 and include a lower rim 114 that extends inwardly toward the lower orifice 115. In this variation, the beverage cartridge 100 can include a lower lid 140, such as formed of an aluminum foil (with a polyethylene film coating) bonded (e.g., heat-sealed) to the lower rim 114 to close the lower orifice 115 and seal the cup 110 against oxygen, moisture, and light ingress through the lower orifice 115. The lower lid 140 can also be puncturable or (“pierceable”) by the outlet needle of the brewing machine.

For example: the cup 110 can include a unitary injection-molded polypropylene structure; the upper lid 130 can include an aluminum foil bonded to the upper rim 112 of the cup 110; the lower lid 140 can include an aluminum foil bonded to the lower rim 114 of the cup 110; the filter 120 can include a conical cellulose paper structure; and the lower lid 140 can cooperate with the cup 110 to define an annular lower internal cup volume 117 that encircles the filter 120.

In one variation, the beverage cartridge 100 also includes a filter guard, such as formed of a food-safe polymer (e.g., polypropylene, polyethylene terephthalate) via injection molding. In particular, the filter guard can function to: support the filter 120; prevent collapse of the filter 120 during injection of water into the upper internal cup volume 116; mechanically retain the filter flange 122 near the upper lid 130; and/or shield the filter 120 from damage by the outlet needle during insertion of the outlet needle through the base of the cup 110 or the lower lid 140. The filter guard can thus be loaded into the cup 110 between the filter 120 and the base of the cup 110 or the lower lid 140.

### 4. Coffee Material

Generally, the beverage cartridge 100 can include a first portion of coffee grounds (or “coffee material 180”) arranged in the upper internal cup volume 116 above the filter 120.

In one implementation, the beverage cartridge 100 includes between nine and fourteen grams of coffee grounds—that is, sufficient coffee grounds to yield between six and twelve ounces (or between 180 and 355 milliliters) of brewed coffee volume characterized as between “strong” and “weak.”

In one example, the coffee grounds are ground according to a medium grind characterized by particle sizes 0.8 and 1.0 millimeter in diameter. Alternatively, the coffee grounds can be ground according to a medium-fine grind characterized by particle sizes 0.6 and 0.8 millimeter in diameter.

However, the coffee material 180 can include any other type, volume, or mass coffee and in any other format or grind size.

### 5. Flavoring

Generally, the beverage cartridge 100 can include a second portion of flavoring: arranged between the filter 120 and the base of the cup 110; and isolated from the first portion of coffee material 180 located above the filter 120. In particular, the beverage cartridge 100 can include between one part and two parts per mass of flavoring per two parts of coffee material 180. For example, the beverage cartridge 100 can include: between ten and fifteen grams of coffee grounds stored in the upper internal cup volume 116; and between seven and fourteen grams of flavoring stored in the lower internal cup volume 117.

In one implementation, the first portion of coffee material 180 includes a first mass of dry coffee grounds; and the second portion of flavoring material 190 includes a second mass of powdered instant creamer, wherein the second mass differs from the first mass by less than 20% such that the beverage cartridge 100 yields a cup 110 of coffee characterized by a coffee strength approximately matched to its creaminess. For example, the beverage cartridge 100 can include: twelve grams of coffee grounds and ten grams of flavoring; or twelve grams of coffee grounds and fourteen grams of flavoring.

### 5.1 Dry Flavoring

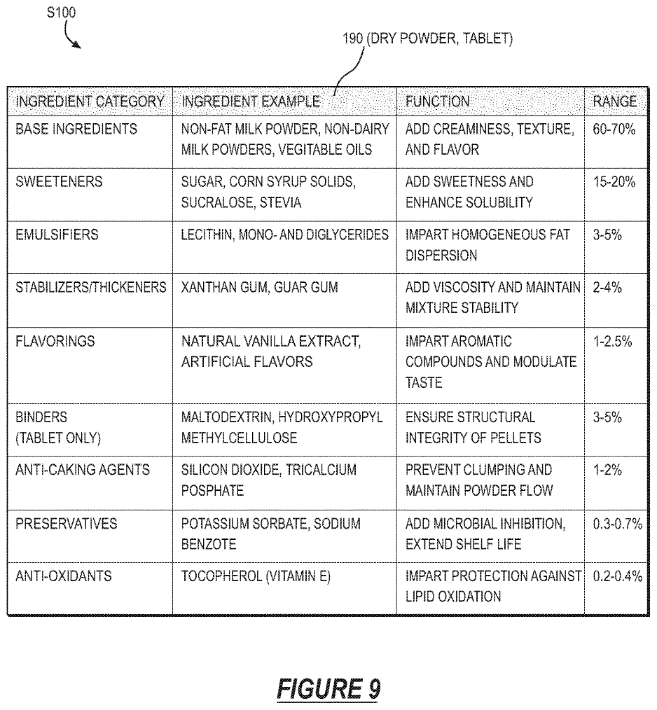

In one implementation shown in FIG. 9, the beverage cartridge 100 stores dry, loose powdered flavoring—such as an instant creamer—in the lower internal cup volume 117.

For example, the flavoring material 190 can include 60-70% by mass non-fat milk powder or non-dairy milk powder, which imparts creaminess, texture, and dairy or plant-based flavors when mixed with a volume of brewed coffee passing through the filter 120 during a brew cycle. The flavoring material 190 can also include 10-15% by mass of sweetener (e.g., sugar, corn syrup solids, sucralose, stevia) that adds sweetness and increases solubility of the flavoring material 190 in a volume of brewed coffee. The flavoring material 190 can further include 2-5% by mass of an emulsifier (e.g., lecithin, mono-or diglyceride) that increases mixture uniformity and reduces separation of the flavoring material 190 when mixed with the volume of brewed coffee. The flavoring material 190 can also include 1-3% by mass of stabilizers or thickeners (e.g., carrageenan, xanthan gum, guar gum, modified starches) that enhance texture and stability of the flavoring material 190 when mixed with the volume of brewed coffee.

In this example, the flavoring material 190 can further include 0.5-1% by mass of an anti-caking agent (e.g., silicon dioxide, tricalcium phosphate) that reduces clumping and increases free-flowing properties of the dry, powdered flavoring when mixed with the volume of brewed coffee in the lower internal cup volume 117. More specifically, the flavoring material 190 can include an anti-caking agent that improves mixing of the powdered flavoring with water flowing into the lower internal cup volume 117.

In this example, the flavoring material 190 can also include 1-2% by mass of natural or artificial flavors (e.g., vanilla solids, cocoa powder) that enhance taste and/or modify a flavor profile of the volume of coffee brewed in the beverage cartridge 100.

In this example, the flavoring material 190 can also include 0.1-0.5% by mass of a preservative (e.g., potassium sorbate, sodium benzoate) that extends shelf life and/or prevents microbial growth in the beverage cartridge 100.

However, the flavoring material 190—in a dry powdered format—can include any other component or ingredient, such as to affect creaminess, flavor, texture, color, solubility, storage stability, stability in hot water, and/or clumping when mixed with hot water within (or outside of the) the lower internal cup volume 117.

### 5.1.1 Powdered Flavoring Amount V. Liquid Creamer

In one implementation, the beverage cartridge 100 can include: a first portion (or mass) of coffee material 180 (e.g., coffee grounds) sufficient to brew a cup of coffee (e.g., a strong eight-ounce, a moderate-strength ten-ounce, or a weak twelve-ounce cup of coffee); and a second portion of powdered flavoring material 190 approximately equivalent to two or three single-serving liquid creamer packets.

For example, a typical coffee consumer may prefer addition of two to three single-serve liquid creamer packets—each containing between five and seven milliliters of liquid creamer—to a cup of coffee. Between four and seven milliliters of liquid creamer may be equivalent to between three and five grams of dehydrated (e.g., dry, powdered) dairy or non-dairy solids. Therefore, the beverage cartridge 100 can include between ten and fourteen grams of powdered flavoring material 190 paired with between nine and fourteen grams of coffee grounds 180. Accordingly, the beverage cartridge 100 can include between ten and fourteen grams of powdered flavoring material 190 paired with between nine and fourteen grams of coffee grounds 180 that—when brewed in a brewing machine-yield a cup of coffee perceived as “milked,” “lightened,” or “creamy” without any further addition of flavoring to the cup of coffee outside of this brew cycle, thereby reducing or eliminating a need for separate coffee condiments. For example, the beverage cartridge 100 can include twelve grams of powdered flavoring material 190 paired with twelve grams of coffee grounds 180 that—when brewed in the brewing machine—yield a cup of coffee perceived as “creamy and balanced” without further addition of flavoring to the cup of coffee outside of this brew cycle.

Furthermore, this quantity of powdered flavoring material 190 can be incorporated into an existing internal volume of the cup 110: without altering the external geometry of the cup 110; without reducing a mass or volume of coffee material 180 within the cup 110; and without reducing compatibility of the beverage cartridge 100 with existing brewing machines.

Therefore, the beverage cartridge 100 can include matched masses of coffee material 180 and powdered flavoring material 190 sufficient to yield a single cup of coffee perceived as “milked,” “lightened,” “creamy,” and/or “balanced” by a typical coffee consumer.

### 5.2 Wet Flavoring

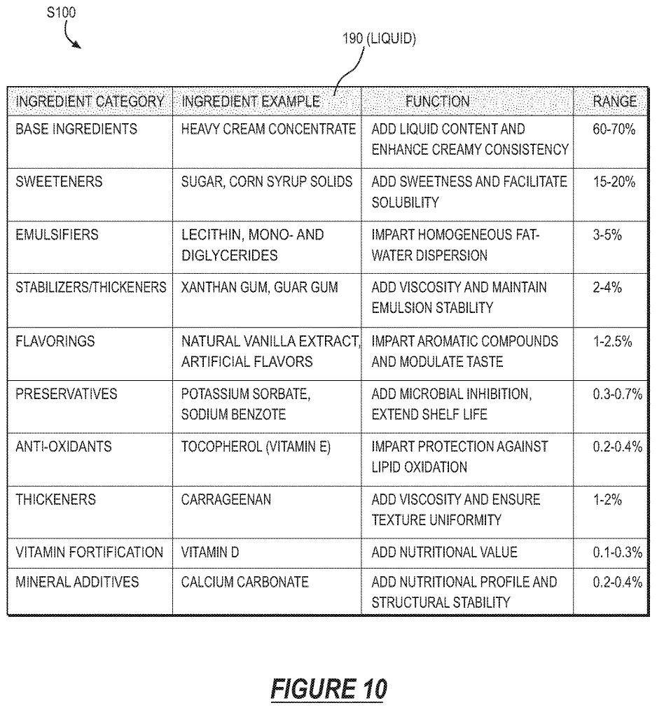

Alternatively, the beverage cartridge 100 can store a liquid (or “wet”) flavoring—such as a creamer concentrate—in the lower internal cup volume 117, shown in FIG. 10.

For example, the flavoring material 190 can include 60-70% by mass of a heavy cream concentrate, which imparts a richness and a creamy texture when mixed with a volume of brewed coffee passing through the filter 120 during a brew cycle. In this example, the flavoring material 190 can also include 15-20% by mass of a sweetener (e.g., sugar, corn syrup, dextrose), which adds sweetness and enhances a flavor profile of the flavoring material 190 when mixed with the volume of brewed coffee. The flavoring material 190 can further include 3-5% by mass of an emulsifier (e.g., lecithin), which can increase mixture uniformity and reduces separation of the flavoring material 190 when mixed with the volume of brewed coffee. The flavoring material 190 can also include 2-4% by mass of a stabilizer (e.g., xanthan gum), which may improve viscosity and stability of the flavoring material 190 when mixed with the volume of brewed coffee, including reducing separation of the flavoring material 190 from the volume of brewed coffee.

In this example, the flavoring material 190 can also include 1-2.5% by mass of natural or artificial flavors (e.g., vanilla extract), which impart a vanilla aroma and enhance an overall taste of the brewed coffee. The flavoring material 190 can further include 0.3-0.7% by mass of a preservative (e.g., potassium sorbate), which may extend a shelf life of the flavoring material 190 by preventing microbial growth within the beverage cartridge 100.

In this example, the flavoring material 190 can further include 0.2-0.4% by mass of an anti-oxidant (e.g., tocopherol, vitamin E) to reduce oxidation and maintain freshness and flavor of the flavoring material 190. The flavoring material 190 can also include 1-2% by mass of a thickener (e.g., carrageenan), which may enhance mouthfeel and consistency of the flavoring material 190 mixed with the volume of brewed coffee.

However, the flavoring material 190—in a liquid or slurry format—can include any other component or ingredient, such as to affect creaminess, flavor, texture, color, solubility, storage stability, and/or stability in hot water.

### 6. Powdered Flavoring in Lower Internal Cup Volume

In one implementation shown in FIG. 1: the first portion of coffee material 180 includes a first mass of coffee grounds; and the second portion of flavoring material 190 includes a second mass of powdered instant creamer. In particular, in this implementation, the beverage cartridge 100 stores: dry, loose coffee grounds in the upper internal cup volume 116; and dry, loose powdered flavoring in the lower internal cup volume 117.

In one example, the cup 110 defines a frustoconical section with an upper rim 112 and continuous base (i.e., absent a lower orifice 115) opposite the upper rim 112. In this example, to assemble the beverage cartridge 100, the second portion of the dry, powdered flavoring is loaded into the cup 110 (such as just before or after an inedible polymer filter guard 150 is loaded into the cup 110). The filter 120 is then installed in the cup 110 above the second portion of the dry, powdered flavoring (and the filter guard), and the first portion of the coffee material 180 (e.g., coffee grounds) is then loaded into the filter 120. Air is then purged from the cup 110 (e.g., with nitrogen) just prior to installing the upper lid 130 across the upper rim 112 of the cup 110 (e.g., via heat sealing or thermal bonding) to seal the coffee material 180, the filter 120, (the filter guard,) and the flavoring material 190 within the cup 110.

In another example in which the beverage cartridge 100 includes both upper and lower lids 130, 140, the cup 110 defines a frustoconical section with: an upper rim 112 extending outwardly and circumscribing an upper orifice 113; and a lower rim 114 extending inwardly and circumscribing a lower orifice 115. In this example, to assemble the beverage cartridge 100, the filter 120 is inserted into the cup 110 via the upper orifice 113 and seated on the filter seat 111 defined by the cup 110. The coffee material 180 is then loaded into the filter 120 via the upper orifice 113. The upper lid 130 is then installed across the upper rim 112 of the cup 110 (e.g., via heat sealing or thermal bonding). The cup 110 is then inverted, and the flavoring material 190 (and the inedible polymer filter guard 150) is then loaded into the cup 110 via the lower orifice 115. Air is then purged from the cup 110 (e.g., with nitrogen) via the lower orifice 115 just before the upper lid 130 is installed across the lower rim 114 of the cup 110 (e.g., via heat sealing or thermal bonding) to seal the coffee material 180, the filter 120, (the filter guard,) and the flavoring material 190 within the cup 110.

However, in this implementation, the beverage cartridge 100 can be assembled—with dry coffee material 180 and dry flavoring—in any other way.

In this implementation, when the beverage cartridge 100 is loaded into the cup receptacle of the brewing machine, the inlet needle of the brewing machine pierces the upper lid 130, and the outlet needle of the brewing machine pierces the base of the cup 110 or the lower lid 140. The inlet needle then injects heated water into the upper internal cup volume 116. This heated water: wets the coffee grounds in the upper internal cup volume 116; extracts flavors from the coffee grounds; passes through the filter 120 into the lower internal cup volume 117; wets and mixes with the dry, loose powdered flavoring in the lower internal cup volume 117; and then exits the beverage cartridge 100 via the outlet needle.

In this implementation, the beverage cartridge 100 can also include an anti-caking agent (e.g., silicon dioxide, tricalcium phosphate) to reduce clumping and improve mixing of the powdered flavoring with water flowing into the lower internal cup volume 117.

### 7. Powdered Flavoring in Upper and Lower Internal Cup Volumes

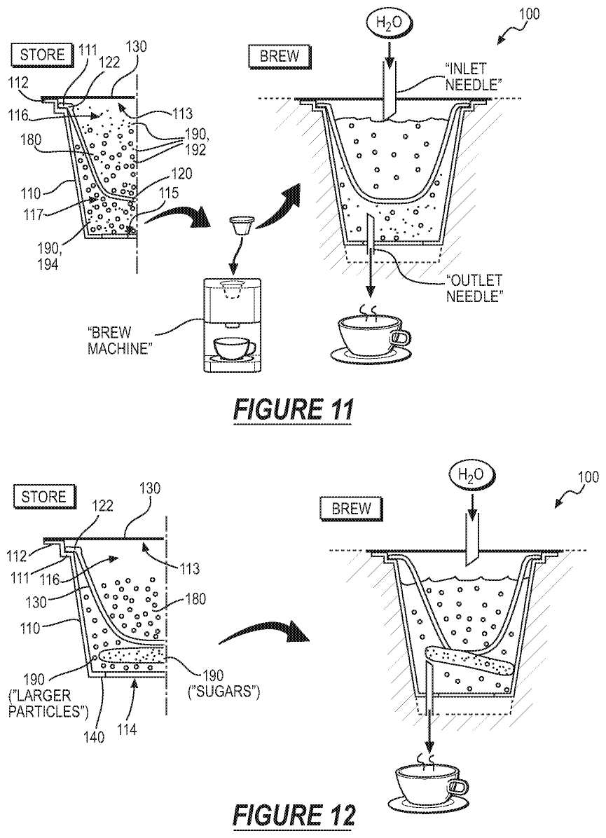

In one variation shown in FIG. 11, the beverage cartridge 100 includes: a cup 110 including an upper rim 112 and a base; a filter 120 arranged within the cup 110 and characterized by a pore size; an upper lid 130 arranged across the upper rim 112 and puncturable by an inlet needle of a brewing machine; a first mass of coffee particles 180; a second mass of sugar particles; and a third mass of flavoring particles 190. The first mass of coffee particles 180: is characterized by a first particle size greater than the pore size; and is arranged between the filter 120 and the upper lid 130. The second mass of sugar particles: is characterized by a second particle size less than the first particle size; is mixed with the first mass of coffee particles 180; occupies interstitial volumes between coffee particles in the first mass of coffee particles 180; and is arranged between the filter 120 and the upper lid 130. The third mass of flavoring particles 190: is characterized by particle sizes greater than the pore size; is arranged between the filter 120 and the base of the cup 110; and cooperates with the second mass of sugar particles to form powdered instant creamer.

Generally, in this variation, insoluble flavoring particles and/or flavoring particles larger than pores of the filter 120—such as milk fats and emulsions—can be loaded into the lower internal cup volume 117 (i.e., below the filter 120). Conversely, soluble flavoring particles and/or flavoring particles smaller than pores of the filter 120—such as sugars—can be loaded into the upper internal cup volume 116, such as located co-spatially with the coffee material 180 above the filter 120.

### 7.1 Partitioning Flavoring Materials by Particle Size and Solubility

More specifically, in this variation, the powdered flavoring material 190 can be partitioned into: a lower payload 194 containing particles that are insoluble, partially soluble, fat-bearing, or dimensionally larger than the filter pore size; and an upper payload 192 containing particles that are fully soluble in hot water and exhibit particle diameters below the filter pore size. The lower payload 194: is stored in the lower internal cup volume 117; is isolated from the coffee material 180 by the filter 120; and can include flavoring particles characterized by hydrophobic or amphiphilic surfaces (e.g., milk fats or fat-associated solids), emulsion fragments, spray-dried fat systems, encapsulated flavor carriers exceeding the pore size, and/or non-soluble or slowly hydrating solids. Furthermore, the lower payload 194 can be characterized by particle dimensions (e.g., diameter) between fifty and two-hundred microns. For example, the lower payload 194 can include: dried milk-fat agglomerates; emulsified dairy solids; and/or lipid-associated carriers.

The upper payload 192: is loaded into the upper internal cup volume 116; is mixed or layered with the coffee material 180; and includes materials characterized by rapid solubility in heated water, particle dimensions less than ten microns, and transport across the filter 120 once dissolved. For example, the upper payload 192 can include: sucrose crystals; confectioner's sugar (e.g., one-to five-microns in diameter); micronized sweeteners; soluble carbohydrate powders; and/or protein powders.

### 7.2 Manufacturing With Separate Upper and Lower Payload 194s

Generally, the beverage cartridge 100 can be assembled by: dispensing the powdered flavoring material 190 into the bottom of the cup 110; bonding the edge of the filter 120 to the rim 112 of the cup 110; and then directing a blast of air into the cup 110 to fully distend the filter 120 into the cup 110, remove wrinkles and folds from the filter 120, and thus substantially maximize a volume between the filter 120 and the rim 112 of the cup 110. The coffee material 180 can then be dispensed onto the filter 120 before sealing the upper lid 130 across the rim 112 of the cup 110.

However, any fine, low-mass particles (e.g., sugars, micronized sweeteners) present in the lower internal cup volume 117 may be upset by the air blast, which may cause these smaller particles to migrate upwardly through the filter 120 and deposit onto the rim 112 of the cup 110, which may interfere with adhesion of the upper lid 130 onto the rim 112 of the cup 110, compromise integrity of this seal, reduce shelf life of the beverage cartridge 100 due to microleaks or partial seal defects, and/or alter a ratio of flavoring material 190 to coffee material 180 in the beverage cartridge 100.

Therefore, in this variation, the beverage cartridge 100 can be assembled by: dispensing the lower payload 194—containing larger particles—into the bottom of the cup 110; bonding the edge of the filter 120 to the rim 112 of the cup 110; and then directing a blast of air into the cup 110 to shape the filter 120 within the cup 110; mixing the coffee material 180 and the upper payload 192; dispensing the coffee material 180 and the upper payload 192 mixture onto the filter 120; and then sealing the upper lid 130 across the rim 112 of the cup 110. Alternatively, the upper payload 192 can be dispensed onto the filter 120 before, after, or while dispensing the coffee material 180 onto the filter 120.

In this implementation, larger particles in the lower payload 194 may remain below the filter 120 during assembly of the beverage cartridge 100 due to the pore size of the filter 120, and small particles in the upper payload 192 may not be loaded into the cup 110 before the air blast is applied, thereby avoiding dispersal of dry powdered material onto sealing surfaces of the cup 110. The lower payload 194 also occupies an otherwise unused lower internal volume 117 of the cup 110, thereby improving total volumetric efficiency of the beverage cartridge 100 while contributing to creaminess or body of the resulting beverage.

Conversely, smaller particles in the upper payload 192—which may migrate through the filter 120—are only loaded into the cup 110 after the air blast is applied. Therefore, the upper payload 192 is not exposed to the air blast, thereby reducing or eliminating risk of these smaller particles contaminating sealing surfaces on the cup 110 or the filter 120 prior to installation of the upper lid 130. In one example: the filter 120 is characterized by a pore size between ten and twenty microns; the upper payload 192 includes soluble solids (e.g., confectioner's sugar, micronized carbohydrates) between one and ten microns in size; and the lower payload 194 includes milk fats and/or emulsified dairy particles between fifty and two-hundred microns in size.

Furthermore, fine sugars and other soluble solids in the upper payload 192 may nest within interstices (or “void fractions”) between coffee particles 180 above the filter 120 and may therefore not materially reduce the mass of coffee grounds 180 that can be loaded into the volume defined between the filter 120 and the upper lid 130. These fine sugars and other soluble solids in the upper payload 192 may dissolve rapidly in the presence of heated water injected into the beverage cartridge 100 and then permeate through the filter 120.

### 8. Powdered Flavoring Tablet in Lower Internal Cup Volume

In another implementation shown in FIG. 3: the first portion of coffee material 180 includes loose coffee grounds; and the second portion of flavoring material 190 includes a powder compressed into a rigid tablet. In this implementation: the tablet is interposed between the filter 120; the lower lid 140 is configured to shield the filter 120 from the outlet needle during insertion of the outlet needle through the base of the cup 110 or the lower lid 140 and/or to support the filter 120 in the filter seat 111); and the tablet is configured to dissolve in liquid (e.g., heated water with extracted coffee oils and particulate) flowing through the filter 120 and into the lower internal cup volume 117.

More specifically, in this implementation, the flavoring material 190 includes a powder compressed into a rigid flavoring tablet: that functions as a filter guard as described above; and that dissolves in coffee passing through the filter 120 and into the lower internal cup volume 117 before exiting the beverage cartridge 100 via the outlet needle. In this implementation, because the flavoring material 190 is compressed into a rigid tablet, the flavoring material 190 can (relatively) slowly dissolve into heater water as this water passes through the filter 120 and washes around the tablet, which may: limit clumping of flavoring material 190; yield more consistent distribution of the flavoring material 190 in the volume of liquid exiting the beverage cartridge 100 during the brew cycle; and yield more consistent dissolution of the flavoring material 190—and thus more consistent flavor and texture—across many cups of coffee brewed from many instances of the beverage cartridge 100.

### 8.1 Tablet Geometry

In this implementation and as shown in FIG. 3, the flavoring material 190 can be compressed into a tablet defining a circular or annular disc configured to locate above and to span a large area of the base of the cup 110 or above the lower lid 140. For example, for the cup 110 characterized by a bottom diameter of 1.5 inches (or 38 millimeters), the flavoring material 190 can be compressed into an annular disc of a mass of ten grams, characterized by a density of 1.5 grams per cubic centimeter, exhibiting an outer diameter of 1.25 inches (or 32 millimeters), exhibiting an inner diameter of 0.2 inches (5 millimeters), and exhibiting a thickness of 0.35 Inches (or 8.5 Millimeters).

The tablet can also include an array of perforations—smaller than the outlet needle—that function to increase an effective surface area of the tablet and thus increase a dissolution rate of the tablet. For example, the tablet can include an array of perforations that increase an effective surface area of the table—and thus increase the dissolution rate of the tablet—such that at least 90% of the tablet dissolves in eight ounces of heated water passing through the beverage cartridge 100 within a 60-second brew cycle. In the foregoing example in which flavoring forms a ten-gram annular tablet, the tablet can include ten holes that are 0.08 inch (or 2 millimeters) in diameter and patterned radially about the inner orifice of the tablet, which may increase a surface area of the tablet by more than 50% and thus increase a dissolution rate of the tablet during a brew cycle.

Additionally or alternatively, the tablet can include a set of ridges or dimples—such as radial or circular ridges or dimples facing the filter 120—that function to increase the effective surface area of the tablet. However, the tablet can define any other geometry.

### 8.2 Binder

In this implementation and shown in FIG. 9, in addition to the components described above, the flavoring material 190 can also include a binder that maintains a structural integrity of the tablet when the beverage cartridge 100 is stored and also during a brew cycle. For example, the flavoring material 190 can include 10% by mass maltodextrin, a cellulose derivative (e.g., hydroxypropyl methylcellulose), or gum arabic.

### 8.3 Brewing and Tablet Dissolution

Therefore, in this implementation, when the outlet needle pierces the base of the cup 110 or the lower lid 140 during a brew cycle, the flavoring material 190 tablet can: shield the filter 120 from puncture by the outlet needle; and (initially) form a rigid framework around the filter 120 to maintain a shape of the filter 120 and to prevent collapse of the filter 120 during injection of heated water under pressure into the upper internal cup volume 116.

When the inlet needle then injects heated water into the upper internal cup volume 116, this heated water: wets the coffee grounds in the upper internal cup volume 116; extracts flavors from the coffee grounds; and passes through the filter 120 into the lower internal cup volume 117. This heated water then: flows around the flavoring material 190 tablet and through holes in the flavoring material 190 tablet; dissolves flavoring off of the surface of the flavoring material 190 tablet; and then exits the beverage cartridge 100 via the outlet needle.

### 8.4 Flavoring Pellets

Alternatively, the flavoring material 190 can be compressed into multiple tablets (or “pellets”) stored between the filter 120 and the base of the cup 110 or the lower lid 140. For example, ten grams of the flavoring material 190 can be compressed into twenty, 0.5-gram lozenge pellets that are 0.16 inch (or 4 millimeters) in diameter and 0.42 inches (or 10.6 millimeters) in thickness. (These pellets can thus exhibit a surface area and dissolution rate similar to the ten-gram annular tablet described above.)

### 8.5 Coated Polymer Filter Guard

In the implementation described above in which the beverage cartridge 100 includes a food-safe polymer insert (e.g., a polymer filter guard 150) configured to support the filter 120, mechanically retain the filter flange 122 near the upper lid 130, and/or shield the filter 120 from damage by the outlet needle, etc., the polymer filter guard 150 can be coated with the powdered flavoring, which can dissolve into heated water flowing through the filter 120 and into the lower internal cup volume 117 during a brew cycle.

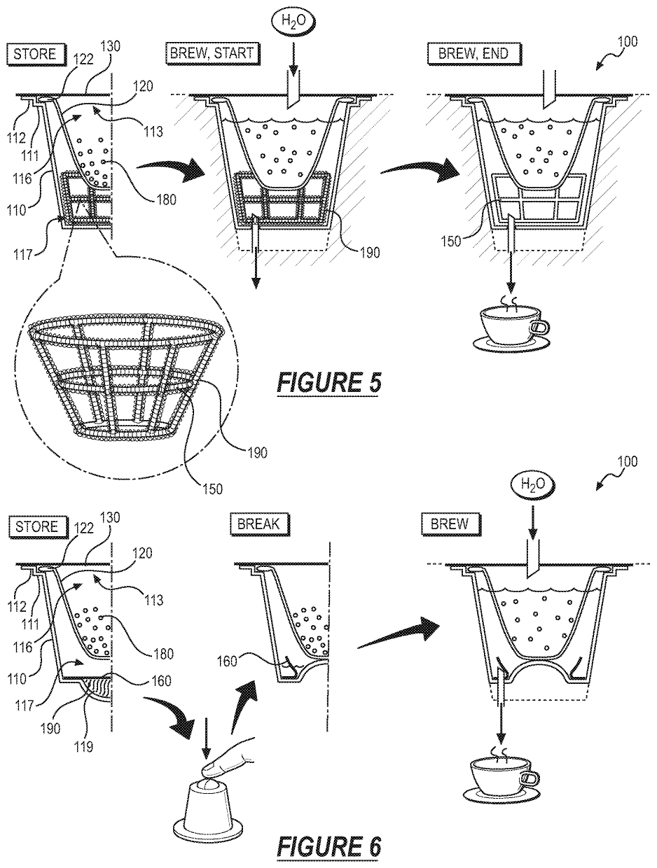

In this implementation and shown in FIG. 5, the insert can be formed of polypropylene, polyethylene terephthalate, or another food-safe polymer, such as via injection molding. As shown in FIG. 5, the insert can also define an annular cage, such as including three annular hoops: of 1.0, 1.125, and 1.25 inches in diameter (or 24, 28, and 32 millimeters) in diameter; 0.8 inch (or 2 millimeters) in thickness; and connected by six equally-space azimuthal or vertical beams 0.8 inch (or 2 millimeters) in thickness. In this implementation, the insert can be coated with the flavoring material 190, such as ten grams of powdered flavoring containing 10% binder by weight and forming a 0.12-inch-thick (or 3-millimeter-thick) coating on all surfaces of the insert.

In this implementation, the flavoring material 190 can be spray-coated, dip-coated, or electrostatically coated onto the insert. However, the insert can define any other geometry and can be coated with the flavoring material 190 in any other way.

### 8.6 Beverage Cartridge Assembly

In this implementation, the flavoring material 190 tablet, flavoring pellets, or flavoring-coated insert can be loaded into the base of the cup 110 before insertion of the filter 120, loading with coffee grounds, and closure of the upper orifice 113 of the cup 110 with the upper lid 130.

However, in this implementation, the beverage cartridge 100 can be assembled with the flavoring material 190 tablet, flavoring pellets, or flavoring-coated insert in any other way.

### 9. Friable Flavoring Tablet for Low-Dust Cartridge Assembly

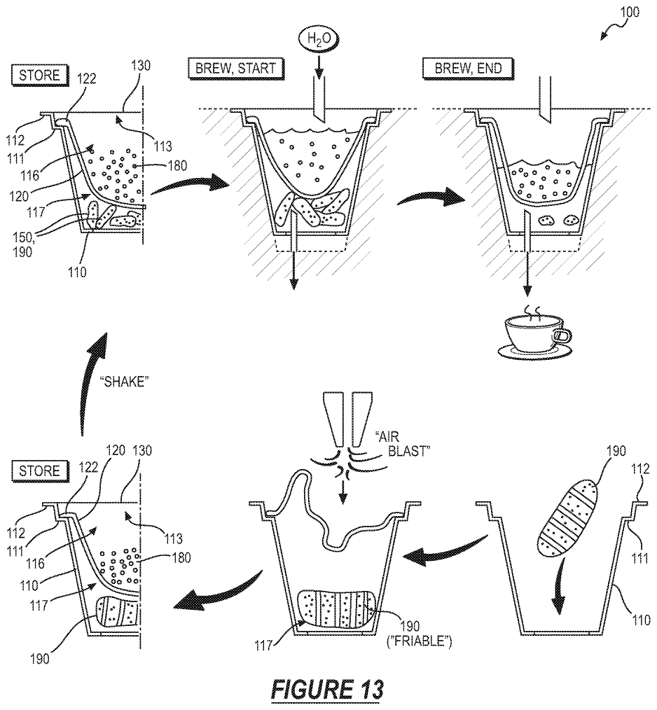

In one variation shown in FIG. 13, the beverage cartridge includes: a first mass of coffee material; a cup including an upper rim and a base; a filter arranged within the cup and characterized by a pore size; an upper lid arranged across the upper rim, cooperating with the filter to define an upper internal cup volume occupied by the first mass of coffee material, and puncturable by an inlet needle of a brewing machine; and a second mass of flavoring material 190. The second mass of flavoring material 190: includes a first portion of flavoring particles characterized by particle sizes greater than the pore size; includes a second portion of sugar particles characterized by particle sizes less than the pore size; is arranged between the filter and the base of the cup; and is formed into a friable tablet configured to a) retain the second portion of sugar particles within the cup during assembly of the beverage cartridge and b) fragment following assembly of the beverage cartridge.

In this variation, the flavoring material 190 is formed into a low-strength, friable tablet—that is, a fragile, frangible, brittle, crisp, and/or easily-broken puck, pellet, or other compressed or bonded mass. In this variation, the friable tablet is configured to: contain fine powdered flavoring material 190 during assembly of the beverage cartridge 100; and to later break and disintegrate into smaller particles following assembly of the beverage cartridge 100, thereby increasing surface area of the powdered flavoring material 190 and improving dissolution rate of the powdered flavoring material 190 during a brew cycle. In particular, during assembly: the friable tablet is loaded into the lower internal cup volume; the filter is positioned over the tablet; an air blast is directed toward the filter to distend and conform the filter within the cup; coffee grounds are loaded onto the filter; and the upper lid is applied to the rim of the cup.

In this variation, because the flavoring material 190 is formed into a friable tablet, fine powdered flavoring material 190 is immobilized and retained during application of the air blast onto the filter, thereby: preventing contamination of sealing surfaces on the filter and/or the rim of the cup; and achieving consistent dosing of powdered flavoring material 190 into the cup. However, because the friable tablet is fragile, the tablet may naturally fracture into smaller particles following assembly of the beverage cartridge 100—such as during transport, regular handling, and/or intentional (vigorous) shaking of the beverage cartridge 100 by a user—before eventually being loaded into a brewing machine. Additionally or alternatively, upon completion of the beverage cartridge 100, the beverage cartridge 100 can be passed over a vibrating table or can otherwise be vibrated or mechanically shaken in order to impact the friable tablet against the wall of the cup, thereby fragmenting the friable tablet immediately after assembly of the beverage cartridge.

### 9.1 Friable Tablet Production

In one implementation, the powdered flavoring material 190 is slightly compressed to form a coherent mass that: retains its solid geometry during assembly of the beverage cartridge 100; is too weak or brittle to survive typical vibration or handling during shipping; and thus fractures into granular fragments before use in a brewing machine. For example, the powdered flavoring material 190 can be compressed to yield a compressive strength between 0.1 and 5 Newtons. In this example, because dairy-based powders may naturally bind under low pressure compression, the powdered flavoring material 190 may exclude additional binders. The powdered flavoring material 190 can thus form a semi-rigid “chalk-like” mass that: survives handling during assembly of the beverage cartridge; fragments under modest shock or shaking; and is carried out of the beverage cartridge via water flowing through a brewing machine during a brew cycle.

Additionally or alternatively, a small amount of liquid water can be mixed into the powdered flavoring material 190, and the powdered flavoring material 190 can then be loaded into a mold compressed into the friable tablet, and then dried. Alternatively, the mold can be wetted with water (or steam, humid air) before loading with dry powdered flavoring material 190. In this implementation, water applied to the powdered flavoring material 190 may partially dissolve lactose or carbohydrate components in the powdered flavoring material 190, thereby enabling the powdered flavoring material 190 to: establish crystalline bridges between adjacent powder particles once dried; and thus form predictable low-strength cohesion within the friable tablet. For example, addition of water to the powdered flavoring material 190 may activate lactose (e.g., via partial dissolution and recrystallization), maltodextrin, corn syrup solids, and/or natural fat content—in the powdered flavoring material 190—as binders.

Additionally or alternatively, the powdered flavoring material 190 can be formed into the friable tablet via thermal crusting techniques. For example, the dry powdered flavoring material 190 can be loaded into a mold. The mold (and/or surrounding air) can then be rapidly heated to high temperature over a short duration to: soften sugar particles in the powdered flavoring material 190 near the surface of the mold; achieves “micro-caramelization” of sugars adjacent the surface mold, which yields a thin, mechanically-stable caramelized-sugar shell that encapsulates the dry powdered core contained therein.

### 9.2 Sweetness/Creaminess Control

In this variation, powdered flavoring material 190 may be loosely formed into the friable tablet such that deliberate shaking of the beverage cartridge 100 prior to loading into a brewing machine fragments the friable tablet into smaller and smaller fragments, thereby incrementally increasing surface area of the powdered flavoring material 190, incrementally increasing a rate of dissolution of the powdered flavoring material 190 into water during a brew cycle, incrementally increasing the total amount of the powdered flavoring material 190 that exits the beverage cartridge 100 during the brew cycle, and thus incrementally increasing the sweetness and/or creaminess of the resulting beverage.

Therefore, minimal shaking of the beverage cartridge 100 before the brew cycle may result in limited fragmentation of the friable tablet and thus a less sweet and less creamy beverage—and vice versa—thereby enabling a user to directly control sweetness and creaminess of the beverage by shaking the beverage cartridge 100 and without opening the beverage cartridge 100 or manually adding other condiments to the beverage.

### 10. Sugar-Based Filter Guard+Separate Flavoring

In another variation shown in FIG. 12, the beverage cartridge 100 includes: a cup 110 including an upper rim 112 and a base; a filter 120 arranged within the cup 110 and characterized by a pore size; an upper lid 130 arranged across the upper rim 112 and puncturable by an inlet needle of a brewing machine; a first mass of coffee material 180 arranged between the filter 120 and the upper lid 130; an edible filter guard; and a third mass of flavoring particles 190. The edible filter guard: includes a second mass of sugar; is arranged between the filter 120 and the base of the cup 110; is configured to shield the filter 120 from an outlet needle of the brewing machine; and is configured to dissolve into liquid passing through the filter 120 and into the outlet needle of the brewing machine during a brew cycle. The third mass of flavoring particles 190: is characterized by particle sizes greater than the pore size; and is arranged around the edible filter guard between the filter 120 and the base of the cup 110.

In this variation, the flavoring material 190 is separated into: a sugar payload; and a non-sugar payload. In this variation, the sugar payload is formed into a solid sugar filter guard: located in the lower internal cup volume 117; configured to shield the filter 120 from the lower needle of the brewing machine at the start of a brew cycle; and configured to dissolve into liquid flowing through the beverage cartridge 100 during a brew cycle to sweeten the resulting beverage. In particular, the sugar payload is pressed, molded, cast, crystallized, caramelized, brûléed, surface-hardened, or otherwise formed into a rigid solid sugar filter guard, such as described above. For example, the rigid solid sugar filter guard can be formed into a perforated disk, honeycomb, or lattice structure of diameter less than a diameter of the base of the cup 110.

During assembly of the beverage cartridge 100, this solid sugar filter guard can be located in the lower internal cup volume 117 (i.e., below the filter 120). The non-sugar payload (i.e., dry powdered flavoring material 190 predominantly or entirely excluding sugars and containing powders of sizes greater than a pore size of the filter 120) is then dispensed into the cup 110 on top of the solid sugar filter guard. The filter 120 is then located in the cup 110, bonded to the rim 112 of the cup 110, and shaped with a blast of air directed into the cup 110. Because the non-sugar payload contains larger particles, these particles may remain within the lower internal cup volume 117 during the air blast. This air blast may also function to settle the non-sugar payload around the solid sugar filter guard and around the filter 120, thereby enabling the filter 120 to fully distend toward the base of the cup 110 with the solid sugar filter guard surrounding the filter 120 and increasing packing efficiency of contents of the beverage cartridge 100. Coffee material 180 is then loaded onto the filter 120, and the upper lid 130 is applied onto the rim 112 of the cup 110.

During a later brew cycle, water passing through the filter 120 into the lower internal cup volume 117 may both: carry the non-sugar payload out of the beverage cartridge 100; and dissolve the solid sugar filter guard and carry sugars from the solid sugar filter guard out of the beverage cartridge 100. Furthermore, because the solid sugar filter guard predominantly or fully dissolves into liquid passed through the beverage cartridge 100 during a brew cycle and the beverage cartridge 100 excludes a separate plastic filter guard, the residual mass of the beverage cartridge 100 may be decreased. In particular, the solid sugar filter guard can function to both protect the filter 120 from the lower needle of the brewing machine and to fully dissolve into the beverage, thereby: limiting food waste; reducing plastic waste (i.e., because a plastic filter guard is fully omitted from the beverage cartridge 100); and increasing spatial efficiency of the beverage cartridge 100 (i.e., a total mass or volume of contents of the beverage cartridge 100 that are dispensed from the beverage cartridge 100 to form a beverage). More specifically, in this variation, the solid sugar filter guard dissolves out of the beverage cartridge 100 to sweeten the resulting beverage rather than remain as a waste element in the beverage cartridge 100 following completion of a brew cycle, thereby increasing effective volumetric efficiency of the beverage cartridge 100.

### 10.2 Separation of Structural Sugar and Other Flavoring Materials

Therefore, in this variation, sugar in the powdered flavoring material 190 can be: separated from other powdered non-sugar components of the powdered flavoring material 190; and formed into a solid sugar body that guards the filter 120 from puncture by the lower needle of a brewing machine at the start of a brew cycle and substantially or fully dissolves upon completion of the brew cycle.

For example, these other dry powdered non-sugar components of the powdered flavoring material 190 can include four grams of powdered fats, emulsified dairy or non-dairy solids, spray-dried fat systems, and/or encapsulated flavor carriers, all of which may be larger than the pore size of the filter 120. In this example, the powdered flavoring material 190 can also include eight grams of sugars, which are separately pressed, molded, cast, crystallized, caramelized, or otherwise formed into a rigid solid sugar body.

### 11. Liquid Flavoring in Bladder

In another implementation shown in FIG. 4, the first portion of coffee material 180 includes loose coffee grounds. The second portion of flavoring material 190 includes: a liquid creamer; and a water-soluble bladder containing the liquid creamer, arranged between the filter 120 and the lower lid 140, and configured to dissolve in liquid flowing through the filter 120 into the lower internal cup volume 117.

In particular, in this implementation, the flavoring material 190 includes a liquid as described above such as: dairy cream and sugar; or a slurry of water, milk, or cream mixed with milk powder, sugar, corn syrup, dextrose, emulsifier, stabilizer or thickener, natural or artificial flavor, and/or preservative. The flavoring material 190 is contained in a water-soluble bladder, such as a thin-film polyvinyl alcohol pouch, and this water-soluble bladder is stored in the lower internal cup volume 117 below the filter 120 of the beverage cartridge 100.

In this implementation, the bladder can include a casing or liner pre-formed (e.g., molded, extruded)—such as with an opening (or “mouth”)—in polyvinyl alcohol. This polyvinyl alcohol casing can then be filled with the flavoring material 190 in liquid form through this opening and then sealed across this opening (e.g., by heat sealing, thermal bonding, or partial gelling through local application of water) to fully enclose the flavoring material 190 within the casing and thus complete the bladder.

In this implementation, the bladder can be loaded in the base of the cup 110 before insertion of the filter 120, loading with coffee grounds, and closure of the cup 110 with the upper lid 130. Alternatively, the bladder can be installed through the lower orifice 115 of the cup 110 and then sealed within the cup 110 by the lower lid 140. However, in this implementation, the bladder can be formed in any other way and with any other material and can be assembled in the beverage cartridge 100 in any other way.

### 11.1 Brewing and Bladder Dissolution

In this implementation, when the outlet needle pierces the base of the cup 110 or the lower lid 140 during a brew cycle, the outlet needle can also pierce the water-soluble bladder such that the liquid flavoring flows out of the lower internal cup volume 117 via the outlet needle and/or flows across the lower internal cup volume 117. Furthermore, when the inlet needle (concurrently) pierces the upper lid 130 and injects heated water into the upper internal cup volume 116, this heated water: wets the coffee grounds in the upper internal cup volume 116; extracts flavors from the coffee grounds; passes through the filter 120 into the lower internal cup volume 117; flows around and dissolves the polyvinyl alcohol casing of the bladder; mixes with the liquid flavoring now released from bladder due to dissolution of the polyvinyl alcohol casing; and then exits the beverage cartridge 100 via the outlet needle.

### 12. Liquid Flavoring in Blister

In another implementation, the second portion of flavoring material 190 includes a liquid creamer, as described above. In this implementation and as shown in FIG. 6, the base of the cup 110: defines a blister 119 extending downwardly opposite the upper lid 130 to form a blister 119 volume; and is puncturable by an outlet needle of the brewing machine. In this implementation, the beverage cartridge 100 further includes an interior seal 160: sealed against the base to enclose the second portion of flavoring material 190 within the blister 119 volume; and configured to unseal from the base and to release the second portion of flavoring material 190 toward the filter 120 responsive to depression of the blister 119 toward the filter 120.

In particular, in this implementation, the base of the cup 110 defines a blister 119 (or semi-spherical dome) extending opposite the filter 120, and the flavoring material 190—in liquid form—is sealed within the blister 119 by an internal seal (e.g., aluminum foil with polyethylene film coating) bonded to the interior face of the base of the cup 110.

The internal seal is configured to rupture and/or delaminate from the base of the cup 110 responsive to increased pressure between the interior seal 160 and the blister 119 resulting from depression of the blister 119 toward the filter 120. For example, the upper lid 130 can be formed of an aluminum foil 0.008 inch (or 0.2 millimeter) in thickness, and the interior seal 160 can be formed of an aluminum foil 0.003 inch (or 0.08 millimeter) in thickness and therefore more likely to rupture in the presence of a pressure differential across the interior seal 160. (In this implementation, the cup 110 can also be formed of a translucent or transparent polymer to enable a user to view into the cup 110 and verify condition of the seal before use of the beverage cartridge 100, such as to avoid brewing a cup 110 of coffee if the interior seal 160 previously failed and released liquid flavoring into the interior of the cup 110.)

The blister 119—formed in the base of the cup 110—can also be centered on an axis of the cup 110 and can define a maximum outer radius less than an offset distance between the center of the cup receptacle and the outlet needle in the brewing machine. Accordingly, the outlet needle: may not contact or pierce the blister 119 or the interior seal 160 when inserted through the base of the cup 110; and may therefore render the blister 119 undisturbed during a brew cycle.

In this implementation, if a user desires a cup 110 of coffee with flavoring, the user may depress the blister 119 inwardly toward the interior of the cup 110 prior to loading the beverage cartridge 100 into the brewing machine, as shown in FIG. 6. The resulting increase in fluid pressure within the blister 119 may cause the internal seal to rupture or to delaminate from the base of the cup 110, thereby releasing the liquid flavoring into the lower internal cup volume 117. Once the user loads the beverage cartridge 100 into the brewing machine, the inlet needle pierces the upper lid 130 of the beverage cartridge 100 and injects heated water into the upper internal cup volume 116. This heated water: wets the coffee grounds in the upper internal cup volume 116; extracts flavors from the coffee grounds; passes through the filter 120 into the lower internal cup volume 117; mixes with the liquid flavoring in the lower internal cup volume 117; and then exits the beverage cartridge 100 via the outlet needle.

However, if the user does not desire a cup 110 of coffee with flavoring, the user can place the beverage cartridge 100 into the cup receptacle in the brewing machine without depressing the blister 119 or rupturing the interior seal 160, thereby preserving the liquid flavoring within the blister 119.

### 12.1 Multiple Blisters

In this implementation, the cup 110 can similarly define multiple blisters 119, each: containing liquid flavoring; sealed with an interior seal 160; and located inside of and/or outside of a circle centered on the base of the cup 110 and of a radius equal to an offset distance between the center of the cup receptacle and the outlet needle in the brewing machine such that the outlet needle clears (i.e., does not pierce) these blisters 119 when the beverage cartridge 100 is loaded into the cup receptacle in the brewing machine.

In this implementation, the user may selectively depress these blisters 119 in order to control an amount of liquid flavoring released into a cup 110 of coffee brewed in the beverage cartridge 100.

### 13. Liquid Flavoring Behind Internal Seal

In another implementation shown in FIG. 7, the beverage cartridge 100 further includes an interior seal 160: arranged in the cup 110; interposed between the filter 120 and the lower lid 140; and cooperating with the lower lid 140 and the cup 110 to enclose the lower internal cup volume 117. The second portion of flavoring material 190 includes a liquid creamer sealed within the lower internal cup volume 117. The beverage cartridge 100 also includes a filter guard (or other food-safe polymer insert): sealed within the lower internal cup volume 117; configured to shield the filter 120 from the outlet needle during insertion of the outlet needle through the lower lid 140; and configured to tear the interior seal 160, to expose the upper internal cup volume 116 to the lower internal cup volume 117, when elevated by the outlet needle during insertion of the outlet needle through the lower lid 140. In this implementation, the cup 110 can also define an intermediate shoulder 118 between the upper rim 112 and the lower rim 114; and the interior seal 160 can be bonded to this intermediate shoulder 118.

### 13.1 Filter Guard

In this implementation and as shown in FIG. 7, the filter guard can define a circular geometry including a radial flat or other structure located on a radius approximating an offset distance between the center of the cup receptacle and the outlet needle in the brewing machine. The filter 120 can also define a set of points (or “spikes”) extending upwardly from this radial flat and configured to pierce the interior seal 160. Accordingly, when the beverage cartridge 100 is loaded into the cup receptacle of the brewing machine, the outlet needle: pierces the base of the cup 110 or the lower lid 140; contacts the filter guard; lifts the filter guard; and drives the points on the filter guard upwardly into the interior seal 160, thereby tearing the interior seal 160 and releasing the liquid flavoring toward the filter 120.

### 13.2 Cup Geometry and Assembly for Interior Seal

In one example, the cup 110 includes a unitary structure formed (e.g., molded, drawn) with: a base (or lower rim 114) extending horizontally across a bottom of the cup 110; the upper rim 112 extending horizontally outwardly from the top of the cup 110; and the intermediate shoulder 118 extending horizontally to connect upper and lower sections of the cup 110, such as offset above the base of the cup 110 by one-third of the total height of the cup 110. In this example, to assemble the beverage cartridge 100 excluding a lower lid 140, the filter guard is placed on the base of the cup 110, the liquid flavoring is loaded into the base of the cup 110 near and below the intermediate shoulder 118, and the interior seal 160 (e.g., an aluminum foil with polyethylene film coating on a single side) is then bonded to the intermediate shoulder 118, such as described above, to enclose the filter guard and the liquid flavoring in the lower internal cup volume 117. The filter 120 is then loaded into the upper orifice 113 of the cup 110, such as with the filter flange 122 of the filter seat 111ed in a filter seat 111 adjacent the upper rim 112 of the cup 110. Coffee grounds are then loaded onto the filter 120, and the upper lid 130 (e.g., aluminum foil with polyethylene film coating on a single side) is bonded to the upper rim 112 of the cup 110 to seal the filter 120 and the coffee grounds within the upper internal cup volume 116 and thus complete the beverage cartridge 100.

In the foregoing example, to assemble the beverage cartridge 100, including the lower lid 140, the interior seal 160 is first bonded to the intermediate shoulder 118, such as described above. The filter guard is then loaded into the lower orifice 115 of the cup 110 and set on the interior seal 160. The lower internal cup volume 117—between the lower orifice 115 and the interior seal 160—is then filled with the liquid flavoring, and the lower lid 140 (e.g., aluminum foil with polyethylene film coating on a single side) is bonded to lower rim 114 of the cup 110 to seal the liquid flavoring within the lower internal cup volume 117. The filter 120 is then loaded into the upper orifice 113 of the cup 110, such as with the filter flange 122 of the filter seat 111ed in a filter seat 111 adjacent the upper rim 112 of the cup 110. Coffee grounds are then loaded onto filter, and the upper lid 130 (e.g., aluminum foil with polyethylene film coating on a single side) is bonded to the upper rim 112 of the cup 110 to seal the filter 120 and the coffee grounds within the upper internal cup volume 116 and thus complete the beverage cartridge 100.

In another example shown in FIG. 7, the cup 110 is assembled from discrete cup sections, including an upper cup section and a lower cup section. The upper cup section can include: the upper rim that extends outwardly from the top of the upper cup section; and an intermediate lower rim extending inwardly from the bottom of the upper cup section. The lower cup section: is formed separately from the upper cup section; includes an intermediate upper rim extending inwardly or outwardly from the top of the lower cup section; and includes the lower rim 114 extending inwardly from the bottom of the lower cup section. In this example, to assemble the beverage cartridge 100, the upper and lower cup sections are formed separately, such as via injection molding. The interior seal 160 (e.g., an aluminum foil with polyethylene film coating on both sides) is bonded to the intermediate lower rim 114 of upper cup section and then to the intermediate upper rim 112 of lower cup section (or vice versa) to form the cup 110 with integral interior seal 160 interposed between and bonded to the upper and lower cup sections. The filter guard is then loaded into the lower orifice 115 of the cup 110 and set on the interior seal 160. The lower internal cup volume 117—between the lower orifice 115 and the interior seal 160—is then filled with the liquid flavoring, and the lower lid 140 (e.g., aluminum foil with polyethylene film coating on a single side) is bonded to lower rim 114 of the cup 110 to seal the liquid flavoring within the lower internal cup volume 117. The filter 120 is then loaded into the upper orifice 113 of the cup 110, such as with the filter flange 122 of the filter seat 111ed in a filter seat 111 adjacent the upper rim 112 of the cup 110. Coffee grounds are then loaded into filter, and the upper lid 130 (e.g., aluminum foil with polyethylene film coating on a single side) is bonded to the upper rim 112 of the cup 110 to seal the filter 120 and the coffee grounds within the upper internal cup volume 116 and thus complete the beverage cartridge 100.

### 13.3 Brew Cycle

In this implementation, when the outlet needle pierces the base of the cup 110 or the lower lid 140 during a brew cycle, the outlet needle can drive the filter guard upwardly against the interior seal 160, thereby: tearing the interior seal 160 and/or delaminating the interior seal 160 from the intermediate shoulder 118; and opening the lower internal cup volume 117 to the upper internal cup volume 116. When the inlet needle (concurrently) pierces the upper lid 130 and injects heated water into the upper internal cup volume 116, this heated water: wets the coffee grounds in the upper internal cup volume 116; extracts flavors from the coffee grounds; passes through the filter 120 into the lower internal cup volume 117; mixes with the liquid flavoring in the lower internal cup volume 117; and then exits the beverage cartridge 100 via the outlet needle.

### 14. Liquid Flavoring in Secondary Internal Vessel

In a similar implementation shown in FIG. 8, the second portion of flavoring material 190 includes a liquid creamer sealed within the lower internal cup volume 117. In this implementation, the beverage cartridge 100 also includes a secondary internal vessel 170: defining a secondary rim bonded to the base of the cup 110 below the filter 120; and cooperating with the base of the cup 110 to define a lower internal cup volume 117 a) containing the second portion of flavoring material 190 and b) isolating the second portion of flavoring material 190 from the filter 120. In this implementation, the secondary rim of the secondary internal vessel 170 is configured to delaminate from the base of the cup 110—thereby releasing the second portion of flavoring material 190 toward the filter 120—responsive to insertion of an outlet needle of the brewing machine through the base of the cup 110.

In particular, in this implementation, the beverage cartridge 100 includes a secondary internal vessel 170 inverted and bonded to the base of the cup 110 to enclose the lower internal cup volume 117. For example, the secondary internal vessel 170 can: be formed of a food-safe polymer (e.g., polypropylene, polyethylene terephthalate), such as via injection molding, blow molding, or thermoforming; define a secondary base and a secondary rim offset from the secondary rim and extending outwardly; and can define a frustoconical geometry similar to and smaller—in height and diameter—than the cup 110. Accordingly, the secondary rim of the secondary internal vessel 170 can be bonded to the base of the cup 110 to enclose the lower internal cup volume 117.

Furthermore, the secondary rim of the secondary can define an outer radius greater than and an inner radius less than an offset distance between the center of the cup receptacle and the outlet needle in the brewing machine. Accordingly, the outlet needle of the brewing machine can contact the secondary rim of the secondary internal vessel 170 after piercing the base of the cup 110 or the lower lid 140 following insertion of the beverage cartridge 100 into the cup receptacle of the brewing machine.

In the implementation described above in which the beverage cartridge 100 excludes a lower lid 140, the secondary rim of the secondary internal vessel 170 can also exhibit a thickness greater than (e.g., twice, thrice) the thickness of the base of the cup 110 such that the outlet needle of the brewing machine may pierce the base of the cup 110, but not the secondary rim. Rather, the secondary rim of the secondary internal vessel 170 can be weakly bonded to the base of the cup 110, such as with a food-safe adhesive that exhibits high adhesivity and low cohesivity such that the adhesive fractures under tension between the base of the cup 110 and the secondary rim of the secondary internal vessel 170 induced by the outlet needle piercing the base of the cup 110 and contacting the thicker—less pierceable—secondary rim.

Alternatively, the cup 110 can include a lower rim 114 and a lower orifice 115, and the beverage cartridge 100 can include a lower lid 140 bonded to the lower rim 114 to seal this lower orifice 115. In this implementation, the secondary rim of the secondary internal vessel 170 can be bonded to the interior surface of the lower rim 114, and the lower lid 140 can be bonded across the outer surface of the lower rim 114 to enclose and seal the lower internal cup volume 117. In this implementation, the secondary rim can be thicker (or otherwise less pierceable) than the lower rim 114 of the cup 110 and can be similarly bonded to the lower rim 114 of the cup 110 such that the outlet needle separates the secondary rim of the secondary internal vessel 170 from the lower rim 114 of the cup 110 rather than pierce the secondary rim.

### 14.1 Beverage Cartridge Assembly

In this implementation, to assemble the beverage cartridge 100 that includes a lower lid 140, the secondary internal vessel 170 can be inverted, and the secondary rim of the secondary internal vessel 170 can be bonded to the interior surface of the lower rim 114 of the cup 110. The lower internal cup volume 117 thus formed between the lower rim 114 of the cup 110 and the secondary internal vessel 170 is then filled with liquid flavoring. The lower lid 140 is then bonded to the outer surface of the lower rim 114 to seal the liquid flavoring within the lower internal cup volume 117. The filter 120 is then loaded into the upper orifice 113 of the cup 110, such as with the filter flange 122 of the filter seat 111ed in a filter seat 111 adjacent the upper rim 112 of the cup 110. Coffee grounds are then loaded into the filter 120, and the upper lid 130 (e.g., aluminum foil with polyethylene film coating on a single side) is bonded to the upper rim 112 of the cup 110 to seal the filter 120 and the coffee grounds within the upper internal cup volume 116 and thus complete the beverage cartridge 100.

### 14.2 Brew Cycle

In this implementation, when the outlet needle pierces the base of the cup 110 or the lower lid 140 during a brew cycle, the outlet needle can also drive against the secondary rim of the secondary internal vessel 170, thereby: delaminating the secondary rim of the secondary internal vessel 170 from the base or the lower rim 114 of the cup 110; and opening the lower internal cup volume 117 to the upper internal cup volume 116. When the inlet needle (concurrently) pierces the upper lid 130 and injects heated water into the upper internal cup volume 116, this heated water: wets the coffee grounds in the upper internal cup volume 116; extracts flavors from the coffee grounds; passes through the filter 120 into the lower internal cup volume 117; mixes with the liquid flavoring in the lower internal cup volume 117; and then exits the beverage cartridge 100 via the outlet needle.

### 15. Beverage Cartridge With Liquid Flavoring for Removal Before Brew Cycle

In yet another implementation, the beverage cartridge 100: stores liquid flavoring sealed within the lower internal cup volume 117; and includes a lower lid 140 with pull tab 142 configured to enable a user to remove the lower lid 140 and to dispense the liquid flavoring into a coffee mug prior to insertion of the beverage cartridge 100 into the cup receptacle of the brewing machine.

In this implementation, the beverage cartridge 100 can include an interior seal 160, as described above, that cooperates with a lower section of the cup 110 and the lower lid 140 to enclose the lower internal cup volume 117. In this implementation, the interior seal 160 can be located at a vertical position within the cup 110 such that the interior seal 160 is reachable and pierceable by the outlet needle.

Alternatively, in this implementation, the beverage cartridge 100 can include a secondary vessel, as described above, bonded to the lower rim 114 (or to the interior wall) of the cup 110 and that cooperates with a lower section of the cup 110 and the lower lid 140 to enclose the lower internal cup volume 117. In this implementation, the secondary rim of the secondary vessel and the lower rim 114 of the cup 110 can circumscribe a radius less than the offset distance between the center of the cup receptacle and the outlet needle in the brewing machine. Accordingly, the outlet needle may pierce the lower rim 114 of the cup 110 to enter the lower internal cup volume 117. Alternatively, the secondary rim of the secondary vessel and the lower rim 114 of the cup 110: can circumscribe a radius approximating the offset distance between the center of the cup receptacle and the outlet needle in the brewing machine; and can both be pierceable by the outlet needle of the brewing machine. Accordingly, the outlet needle may pierce both the secondary rim of the secondary vessel and the lower rim 114 of the cup 110 to enter a volume exposed to the filter 120 in order to access water exiting the filter 120.

In this implementation, the lower internal cup volume 117 can be filled with the liquid flavoring and then sealed with the lower lid 140, such as an aluminum foil lid with integral pull tab 142. Thus, in this implementation, a user may: draw the lower lid 140 off of the bottom of the beverage cartridge 100—via the integral pull tab 142—to open the lower internal cup volume 117; dispense the liquid flavoring from the lower internal cup volume 117 into a coffee mug; install the beverage cartridge 100 in the cup receptacle of the brewing machine; and then initiate a brew cycle.

### 16. Powdered Flavoring Behind Removable Lower Lid

In a similar implementation shown in FIG. 2: the cup 110 defines a lower rim 114 and a lower orifice 115; the flavoring material 190 includes a dry, loose powdered flavoring as described above; and the beverage cartridge 100 includes the lower lid 140—with integral pull tab 142—bonded to the lower rim 114 of the cup 110 and sealing the flavoring material 190 within the cup 110.

For example, in this implementation, the first portion of coffee material 180 can include loose coffee grounds; and the second portion of flavoring material 190 can include powdered instant creamer arranged between the filter 120 and the lower lid 140. In this example, the lower lid 140: includes a pull tab 142; and is removable from the lower rim 114 of the cup 110 to release the second portion of flavoring material 190 into a vessel prior to insertion of the cup 110 into the brewing machine.

In particular, in this implementation, the beverage cartridge 100: stores dry, loose powdered flavoring in the lower internal cup volume 117; and includes a lower lid 140 (e.g., aluminum foil) with integral pull tab 142. In this implementation, prior to insertion of the beverage cartridge 100 into the cup receptacle of a brewing machine, a user may remove the lower lid 140 from the cup 110 via the pull tab 142 and dispense the powdered flavoring into a coffee mug. When the inlet needle injects heated water into the upper internal cup volume 116, this heated water: wets the coffee grounds in the upper internal cup volume 116; extracts flavors from the coffee grounds; passes through the filter 120 into the cup receptacle of the brewing machine; and then flows into through the outlet needle—arranged in a base of the cup receptacle—into the coffee mug.

### 17. Beverage Ratio and Internal Volume Allocation

Furthermore, the beverage cartridge 100 can be configured for use with brewing machines limited to discrete brew volumes, such as six-ounce, eight-ounce, or twelve-ounce brew cycles. Accordingly, the mass ratio of coffee material 180 to powdered flavoring material 190, as well as the geometry of the filter 120 and the relative sizes of the upper and lower internal cup volumes 116, 117, can be selected to produce beverages of different styles—including drip-style coffee, lightly creamed coffee, café-au-lait-style beverages, and milk-forward beverages—without requiring changes to the brewing machine or to an external geometry of the beverage cartridge 100.

In this variation, a beverage system can include: a first beverage cartridge; and a second beverage cartridge. The first beverage cartridge can be configured to produce a first brewed beverage of a first beverage type and include: a first mass of coffee material; a first cup defining a cup geometry and including a first upper rim and a first base puncturable by an outlet needle of a brewing machine; a first filter arranged within the first cup and isolating a first upper internal cup volume of the first cup from a first lower internal cup volume of the first cup; a first upper lid arranged across the first upper rim, cooperating with the first filter to enclose the first mass of coffee material within the first upper internal cup volume, and puncturable by the inlet needle of the brewing machine; and a first mass of powdered flavoring material arranged between the first filter and the first base of the first cup.

The second beverage cartridge is configured to produce a second brewed beverage of a second beverage type different from the first beverage type. The second beverage cartridge can include: a second mass of coffee material less than the first mass of coffee material; a second cup defining the cup geometry and including a second upper rim and a second base puncturable by the outlet needle of the brewing machine; a second filter arranged within the second cup and isolating a second upper internal cup volume of the second cup from a second lower internal cup volume of the second cup, the second upper internal cup volume of the second cup smaller than the first upper internal cup volume of the first cup; a second upper lid arranged across the second upper rim, cooperating with the second filter to enclose the second mass of coffee material within the second upper internal cup volume, and puncturable by the inlet needle of the brewing machine; and a second mass of powdered flavoring material greater than the first mass of powdered flavoring material arranged between the second filter and the second base of the second cup.

### 17.1 Drip Coffee

As described above, the beverage cartridge 100 can be configured to brew a cup of drip-style coffee augmented with a powdered creamer, wherein a first portion of coffee material 180 and a second portion of powdered flavoring material 190 are stored in proportions selected to approximate common manual addition of liquid creamer to brewed coffee. For example, the beverage cartridge 100 can include dry coffee grounds and powdered creamer in proportions that—when brewed—yield an eight-ounce cup of drip-style coffee with an amount of creamer equivalent to manual addition of two or three single-serve liquid creamer portions (e.g., two or three 0.4-ounce servings of half-and-half). In this implementation, the powdered flavoring material 190 may include the powdered dairy or non-dairy creamer formulated to dissolve into liquid passing through the beverage cartridge 100 during a brew cycle, such that the resulting beverage exhibits creaminess and mouthfeel comparable to drip coffee prepared with separately added liquid creamer.

In this implementation, the first portion of coffee material 180 and the second portion of powdered flavoring material 190 can be selected to exhibit a mass ratio of approximately one-to-one, such as within ±20% of parity, as described above. For example, the beverage cartridge 100 can include between ten and fourteen grams of coffee grounds and between ten and fourteen grams of powdered creamer. In this example, the beverage cartridge 100 can be configured to brew an eight-ounce beverage characterized by a brewed-coffee-to-liquid-creamer equivalent ratio of approximately eight-to-one, consistent with a typical consumer preference for lightly creamed drip coffee. In this implementation, the filter 120 can define a frustoconical geometry that extends deep into the cup 110 to partition an internal volume of the cup 110 into an upper internal cup volume 116 and a lower internal cup volume 117 of approximately equal volume.

### 17.2 Café Au Lait

In another implementation, the beverage cartridge 100 is configured to brew a café-au-lait-style beverage, wherein a first portion of coffee material 180 and a second portion of powdered flavoring material 190 are stored in proportions selected to yield a beverage characterized by approximately equal volumes of brewed coffee and creamer. For example, the beverage cartridge 100 can include a mass ratio of approximately one-to-four (±10%) of coffee grounds to powdered creamer. In this example, the beverage cartridge 100 can be configured to brew a six-ounce beverage including approximately three ounces of brewed coffee and approximately three ounces of creamer equivalent.

In this implementation, the filter 120 can define a frustoconical geometry that extends partially into the cup 110 to partition the internal volume of the cup 110 into an upper internal cup volume 116 containing approximately twenty percent of the total internal volume and a lower internal cup volume 117 containing approximately eighty percent of the total internal volume. In this configuration, the smaller upper internal cup volume 116 contains a reduced mass of coffee material 180 sufficient to produce a concentrated coffee extraction while the larger lower internal cup volume 117 contains a greater mass of powdered flavoring material 190 that dissolves into liquid passing through the beverage cartridge 100 during the brew cycle to produce a café-au-lait-style beverage.

### 17.3 Latte

In yet another implementation, the beverage cartridge 100 is configured to brew a milk-forward beverage with a reduced coffee fraction. For example, the beverage cartridge 100 can include a mass ratio of approximately one-to-eight (±10%) of coffee grounds to powdered creamer. In one example, the beverage cartridge 100 can be configured to brew a six-ounce beverage including approximately one-and-a-half ounces of brewed coffee and approximately four-and-a-half ounces of creamer equivalent.

In this implementation, the filter 120 can define a shallow semi-spherical geometry that partitions the internal volume of the cup 110 into an upper internal cup volume 116 containing approximately twelve percent of the total internal volume and a lower internal cup volume 117 containing approximately eighty-eight percent of the total internal volume. In this configuration, the upper internal cup volume 116 contains a relatively small mass of coffee material 180 configured to yield a concentrated coffee extraction, while the lower internal cup volume 117 contains a substantially larger mass of powdered flavoring material 190 configured to dissolve into liquid passing through the beverage cartridge 100 during the brew cycle.

### 17.4 Red-Eye Beverage

In another implementation, the beverage cartridge 100 is configured to brew a red-eye-style beverage, wherein a first portion of coffee material 180 is stored in the upper internal cup volume 116 and a second portion of flavoring material 190 stored in the lower internal cup volume 117 includes instant espresso. In this implementation, the beverage cartridge 100 is configured to produce a brewed coffee beverage augmented with an additional espresso equivalent dissolved from the lower internal cup volume 117 during a brew cycle.

For example, the beverage cartridge 100 can include between nine and fourteen grams of coffee grounds stored in the upper internal cup volume 116 and between five and nine grams of instant espresso powder stored in the lower internal cup volume 117. In this example, the beverage cartridge 100 can be configured to brew an eight-ounce beverage including approximately seven ounces of drip-style brewed coffee extracted from the coffee grounds and approximately one ounce of espresso-equivalent dissolved from the instant espresso powder, corresponding to a conventional red-eye beverage profile.

In this implementation, the mass ratio of coffee grounds to instant espresso powder can be approximately one-to-one or two-to-one (±20%), depending on a desired strength of the espresso component relative to the brewed coffee component. The instant espresso powder may dissolve rapidly in liquid passing through the filter 120 and into the lower internal cup volume 117 during the brew cycle, such that the espresso component is fully integrated into the brewed coffee prior to exiting the beverage cartridge 100.

In this implementation, the filter 120 can define a frustoconical geometry that partitions the internal volume of the cup 110 into an upper internal cup volume 116 sized to contain the coffee grounds and a lower internal cup volume 117 sized to contain the instant espresso powder, without requiring changes to an external geometry of the beverage cartridge 100 or to a brewing machine configured to brew fixed volumes such as six-, eight-, or twelve-ounce beverages.

### 17.5 Dirty Chai Beverage

In another implementation, the beverage cartridge 100 is configured to brew a dirty-chai-style beverage, wherein a first portion of coffee material 180 is stored in the upper internal cup volume 116 and a second portion of flavoring material 190 stored in the lower internal cup volume 117 includes a chai powder. In this implementation, the beverage cartridge 100 is configured to produce a chai-based beverage augmented with brewed coffee extracted from the coffee grounds during a brew cycle.

For example, the beverage cartridge 100 can include between four and eight grams of coffee grounds stored in the upper internal cup volume 116 and between eighteen and thirty grams of chai powder stored in the lower internal cup volume 117. In this example, the beverage cartridge 100 can be configured to brew a six-ounce beverage including approximately one to two ounces of brewed coffee extracted from the coffee grounds and approximately four to five ounces of chai-equivalent liquid dissolved and extracted from the chai powder, corresponding to a milk-forward dirty-chai beverage profile.

In this implementation, the mass ratio of coffee grounds to chai powder can be approximately one-to-three to one-to-five (±20%), depending on a desired intensity of chai flavor relative to coffee flavor. The chai powder may include tea solids, spices, sweeteners, and powdered dairy or non-dairy components configured to dissolve and/or extract into liquid passing through the filter 120 and into the lower internal cup volume 117 during the brew cycle.

In this implementation, the filter 120 can define a shallow semi-spherical geometry that partitions the internal volume of the cup 110 into a relatively smaller upper internal cup volume 116 containing the coffee grounds and a relatively larger lower internal cup volume 117 containing the chai powder. In this configuration, the beverage cartridge 100 can produce a dirty-chai-style beverage without requiring manual addition of milk, sweetener, or spices outside of the brew cycle and without modifying a brewing machine configured to brew fixed volumes such as six-or eight-ounce beverages.

As a person skilled in the art will recognize from the previous detailed description and from the figures and claims, modifications and changes can be made to the embodiments of the invention without departing from the scope of this invention as defined in the following claims.

I claim:

1. A beverage cartridge comprising:
a cup comprising:
an upper rim; and
a base;
a filter:
arranged within the cup; and
characterized by a pore size;
an upper lid:
arranged across the upper rim; and
puncturable by an inlet needle of a brewing machine;
a first mass of coffee material arranged between the filter and the upper lid;
an edible filter guard:
comprising a second mass of sugar;
arranged between the filter and the base of the cup;
configured to shield the filter from an outlet needle of the brewing machine; and
configured to dissolve into liquid passing through the filter and into the outlet needle of the brewing machine during a brew cycle; and
a third mass of flavoring particles:
characterized by particle sizes greater than the pore size; and
arranged around the edible filter guard between the filter and the base of the cup.

2. The beverage cartridge of claim 1, wherein the second mass of sugar is cast to form the edible filter guard.

3. The beverage cartridge of claim 1:
wherein the second mass of sugar and the third mass of flavoring particles form a powdered instant creamer; and
wherein a sum of the second mass and the third mass differs from the first mass by less than 20%.

4. A beverage cartridge comprising:
a cup comprising:
an upper rim; and
a base;
a filter:
arranged within the cup; and
characterized by a pore size;
an upper lid:
arranged across the upper rim; and
puncturable by an inlet needle of a brewing machine;
a first mass of coffee particles:
characterize by a first particle size greater than the pore size; and
arranged between the filter and the upper lid;
a second mass of sugar particles:
characterized by a second particle size less than first particle size;
mixed with the first mass of coffee particles;
occupying interstitial volumes between coffee particles in the first mass of coffee particles; and
arranged between the filter and the upper lid; and
a third mass of flavoring particles:
characterized by particle sizes greater than the pore size;
arranged between the filter and the base of the cup; and
cooperating with the second mass of sugar particles to form powdered instant creamer.

5. The beverage cartridge of claim 4, wherein the second mass of sugar particles comprises confectioners sugar.

6. The beverage cartridge of claim 4:
wherein the filter is bonded to the rim of the cup following dispensation of the third mass of flavoring particles into the cup; and
wherein the first mass of coffee particles and the second mass of sugar particles are dispended onto the filter following application of an air blast into the cup to shape the filter within the cup.

7. The beverage cartridge of claim 4:
wherein the second mass of sugar particles and the third mass of flavoring particles form a powdered instant creamer; and
wherein a sum of the second mass and the third mass differs from the first mass by less than 20%.

8. A beverage cartridge comprising:
a first portion of coffee material comprising loose coffee grounds;
a cup comprising:
an upper rim; and
a base;
a filter arranged within the cup;
an upper lid:
arranged across the upper rim;
cooperating with the filter to define an upper internal cup volume occupied by the first portion of coffee material; and
puncturable by an inlet needle of a brewing machine; and
a second portion of flavoring material:
comprising a powder compressed into a rigid tablet arranged between the filter and the base of the cup;
isolated from the first portion of coffee material;
configured to shield the filter from an outlet needle of the brewing machine during insertion of the outlet needle through the base of the cup; and
configured to dissolve in liquid flowing through the filter and toward the outlet needle.

9. The beverage cartridge of claim 8:
wherein the cup further comprises a lower rim;
further comprising a lower lid:
arranged across the lower rim of the cup;
comprising a pull tab; and
removable from the lower rim of the cup to release the second portion of flavoring material into a vessel prior to insertion of the cup into the brewing machine; and
wherein the second portion of flavoring material:
comprises powdered instant creamer; and
is arranged between the filter and the lower lid.
